(19) United States
(12) Patent Application Publication
(10) Pub. No.: US 2014/0108190 A1
(43) Pub. Date: Apr. 17, 2014

(54) RECOMMENDING PRODUCT INFORMATION

(71) Applicant: Alibaba Group Holding Limited, George Town (KY)

(72) Inventor: Shengqiao Kang, Hangzhou (CN)

(21) Appl. No.: 14/053,046

(22) Filed: Oct. 14, 2013

(30) Foreign Application Priority Data
Oct. 16, 2012 (CN) 201210392599.9

(51) Int. Cl. G06Q 30/06

(52) U.S. Cl. CPC G06Q 30/0631
USPC 705/26.7

(57) ABSTRACT

Recommending product information is disclosed, including: classifying a plurality of product prices associated with a category of products into a plurality of actual price intervals based at least in part on historical user actions associated with a plurality of users with respect to products associated with the category, wherein each actual price interval comprises a subset of the plurality of product prices; determining a purchasing power interval for a current user based at least in part on historical user actions associated with the current user with respect to the products associated with the category; and determining product information associated with one or more products of the products associated with the category to be recommended to the current user based at least in part on an actual price interval of the plurality of actual price intervals that corresponds to the purchasing power interval.

### CROSS REFERENCE TO OTHER APPLICATIONS

This application claims priority to People's Republic of China Patent Application No. 201210392599.9 entitled METHOD AND DEVICE FOR PUSHING COMMODITY INFORMATION, filed Oct. 16, 2012 which is incorporated herein by reference for all purposes.

### FIELD OF THE INVENTION

The present application relates to the field of information processing technology. Specifically, the present application relates to techniques for recommending product information.

### BACKGROUND OF THE INVENTION

In order to manage product information on offered products, sometimes, e-commerce websites organize various products into a category tree that is based on a logical form. The nodes in the category tree comprise root categories, sub-categories, and leaf categories. Leaf categories belong to sub-categories, and sub-categories belong to root categories. For example, in a category tree for the category of women's apparel, the root category is women's apparel. Sub-categories under the women's apparel root category include the sub-category of tops and the sub-category of pants. Leaf categories under the tops sub-category include the leaf category of blouses and the leaf category of sweaters.

E-commerce websites also typically classify the prices that correspond to the products associated with a category. In some instances, an e-commerce website classifies product prices associated with the same category into multiple, continuous price intervals. Each price interval comprises a subset of the price range associated with all the products of the category. Conventionally, price intervals are determined using the area equal-division technique. For example, the various product prices are determined for a category, and the multiplication product of each product price and the number of users who perform an online shopping action associated with a product of that product price of that category is determined as the price total for that product price. After adding together the price totals for the various product prices associated with that category, the price totals are divided into three price intervals corresponding to the category based on two division value points. These three price intervals correspond to the high price interval, the medium price interval, and the low price interval. Each product associated with the category is then determined to be associated with one of the three price intervals based on comparing the price of the product to the price range associated with each price interval.

The product price intervals that are determined for each category may be used as the basis for various applications. For example, a user's purchasing power for a category of the products may be determined, and then products in that category that are associated with a price interval that corresponds to the user's purchasing power may be recommended to the user. For example, a user's purchasing power is determined based on the user's historical user actions associated with the e-commerce website. Examples of user actions associated with the e-commerce websites include purchasing actions, browsing actions, and/or saving actions with respect to one or more products that are offered at the e-commerce websites. If the user performs more historical user actions associated with products associated with a category that correspond to the high price interval determined for the category, then the user's purchasing power in the category is determined to be a high purchasing power interval. When product information is to be recommended to the user, a search is performed for product information of products that match the user's purchasing power interval within the category, and therefore, product information of products that are associated with the high price interval, which corresponds to the user's high purchasing power interval, is recommended to the user.

However, some drawbacks exist for the previously described area equal-division technique of recommending product information. Below are a couple of such drawbacks:

The first drawback is associated with the presence of abnormal product prices in a category. An abnormal product price comprises a price that differs greatly from other product prices associated with the same category. For example, if most products associated with a category cost $50 dollars each, but one product associated with the category costs $10,000 dollars, then in the area equal-division technique, generally, the abnormal product prices, such as the $10,000 price, may be manually excluded from the price interval determinations by an operator (e.g., because the product prices are assumed to be incorrect). However, the effectiveness of manually excluding abnormal product prices is generally related to the experience of the operators and of their familiarity with the products. Sometimes, even though a product price appears abnormal, it may still be correct and if it were to be manually excluded by an operator, then the determined price intervals may be inaccurate.

The second drawback is associated with a narrow range of product prices associated with a category of products. When the range of product prices for a category is narrow, it is difficult to determine price intervals for the category that do not overlap and as such, product information recommendation may not be determined based on such incomplete price intervals.

When product information is recommended to a user, the use of inaccurate and incomplete category price interval data as caused by the drawbacks described above will lead to at least two problems: First, if the categories that matter to the user do not have adequate price intervals, the system will be unable to recommend appropriate product information to the user. Second, if matching product information to recommend to the user is unable to be found in a category that matters to the user, the system will carry out multiple matching processes and will not stop until a condition for termination of the matching process is met. Repeated matching processes may consume many system resources and lower overall system processing efficiency.

### BRIEF DESCRIPTION OF THE DRAWINGS

Various embodiments of the invention are disclosed in the following detailed description and the accompanying drawings.

FIG. 1 is a diagram showing an embodiment of a system for recommending products.

FIG. 2 is a flow diagram showing an embodiment of a process for recommending products based on actual price intervals.

FIG. 3 is a flow diagram showing an embodiment of a process for determining a plurality of actual price intervals associated with a category and a purchasing power interval for a current user.

FIG. 4 is a flow diagram showing an embodiment of a process for determining user clusters that correspond to training price intervals.

FIG. 5 is a flow diagram showing an embodiment of a process of determining an actual price interval boundary point corresponding to a training price interval.

FIG. 6 is a diagram showing an embodiment of a system for recommending product information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of recommending product information are described herein. Product prices associated with a category of products are classified into a plurality of actual price intervals based at least in part on historical user actions associated with a plurality of users with respect to products associated with the category. An actual price interval comprises a subset of the plurality of product prices associated with the category. For a current user to whom product information is to be recommended, a purchasing power interval of the current user is determined based at least in part on historical user actions associated with the current user with respect to the products associated with the category. In various embodiments, the purchasing power interval for the current user is selected to correspond to an actual price interval. Information of products associated with prices that correspond to the actual price interval that corresponds to the current user's purchasing power interval is recommended to the user. For example, product information includes descriptions, images, and/or user feedback associated with products.

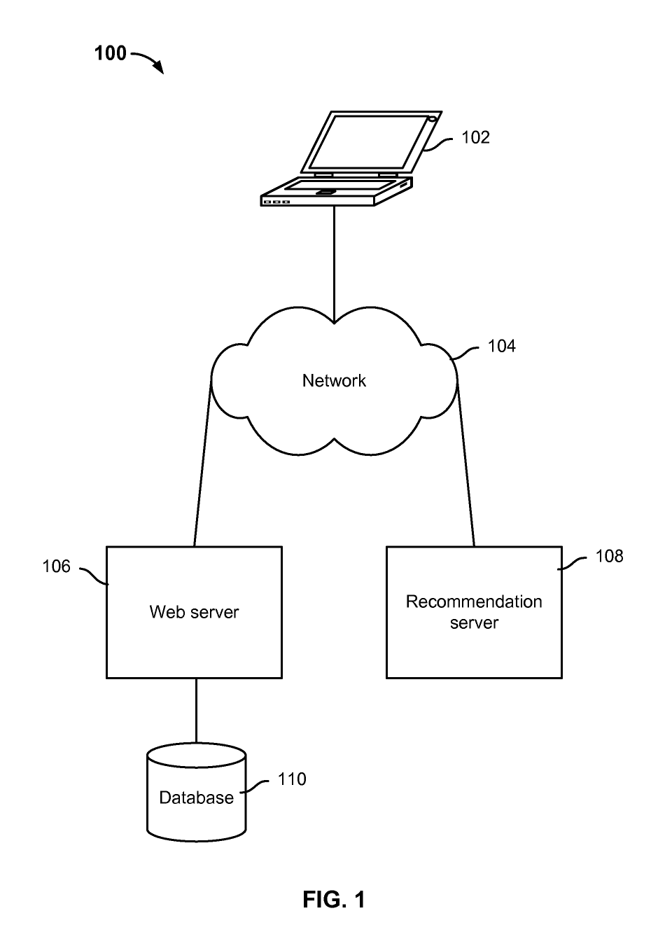

FIG. 1 is a diagram showing an embodiment of a system for recommending products. In the example, system 100 includes device 102, network 104, web server 106, recommendation server 108, and database 110. Network 104 includes high speed data networks and/or telecommunications networks. Device 102, web server 106, and recommendation server 108 are configured to communicate to each over network 104.

While device 102 is shown as a laptop computer in the example, other examples of device 102 include a desktop computer, a smartphone, a tablet device, a mobile device, and/or another type of computing device. A user may use device 102 to access a website hosted by web server 106 using a web browser application executing at device 102. For example, the website comprises an e-commerce website. The e-commerce website may include various webpages corresponding to various products that are offered for sale. While browsing webpages associated with different products at the website, the user may perform various user actions. Examples of user actions may include clicking actions, browsing actions, purchasing actions, searching actions, and/or bookmarking actions. Each user action is associated with a product, the category to which the product belongs (e.g., based on a categorization scheme of the website), and a price associated with the product. Records of such user actions associated with the user of device 102 and various other users are stored at database 110. Other product information, such as descriptions, prices, and/or images of products associated with the website hosted by web server 106 may be stored at database 110 as well.

Recommendation server 108 is configured to recommend product information associated with products associated with the website hosted by web server 106 to a current user based at least in part on the historical user actions stored by database 110. First, recommendation server 108 is configured to classify the product prices associated with a category of products into a plurality of actual price intervals based at least in part on historical user actions associated with a plurality of users with respect to products associated with the category. Each actual price interval comprises a subset of the plurality of product prices. Recommendation server 108 is configured to determine a purchasing power interval for the current user based on the current user's historical user actions (e.g., stored in database 110). An actual price interval determined for the category that matches the current user's purchasing power interval is determined as the matching actual price interval. Recommendation server 108 is configured to send product information associated with the products of the category whose prices are associated with the matching actual price interval to the current user (e.g., at a device used by the current user).

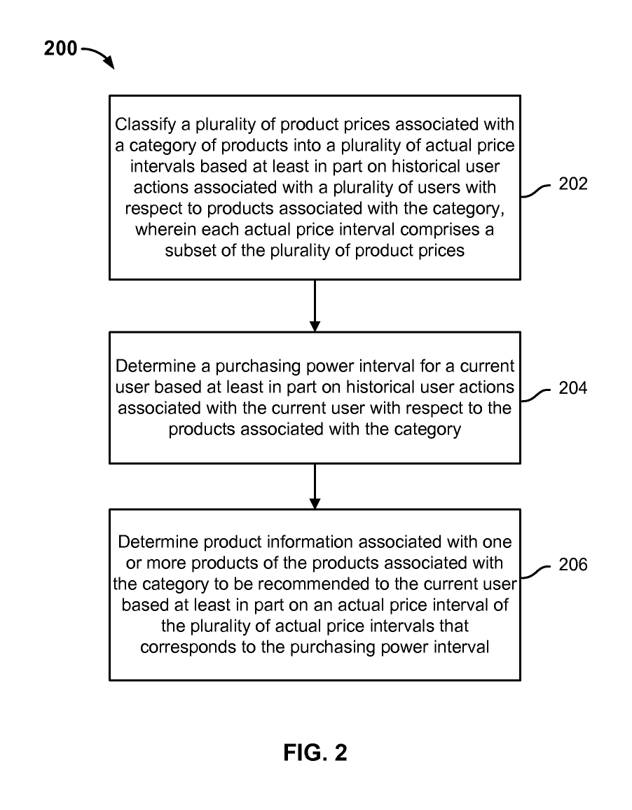

FIG. 2 is a flow diagram showing an embodiment of a process for recommending products based on actual price intervals. In some embodiments, process 200 is implemented at system 100 of FIG. 1.

While actual price intervals may be determined for one or more categories of products, process 200 shows the example of determining the actual price intervals for a single category and determining products from that category to recommend to a user based on the actual price intervals determined for that category and the user's determined purchasing power interval. Process 200 may be repeated for each category or multiple categories from which products are to be recommended to the user.

At 202, a plurality of product prices associated with a category of products is classified into a plurality of actual price intervals based at least in part on historical user actions associated with a plurality of users with respect to products associated with the category, wherein each actual price interval comprises a subset of the plurality of product prices.

As used herein, a “user action” refers to a user action at a website in connection with a product of a certain category and a certain product price. For example, the website comprises an e-commerce website. Examples of user actions include user clicking actions, browsing actions, purchasing actions, searching actions, and/or bookmarking actions. The subject of the user actions may comprise product information or pages that provide product information.

A category may include products that correspond to multiple prices. One or more products associated with the category may be associated with the price. The price range associated with the category comprises the lowest price and the highest price of the prices of products associated with the category. For example, the set of prices associated with the category of the example includes $10, $14, $19, and $27.

In various embodiments, the product prices corresponding to a category are divided into two or more subsets, where each subset of product prices is referred to as an “actual price interval.” In various embodiments, the actual price intervals for a category of products is determined based on historical user actions associated with products of the category. Because each historical user action is associated with a product and the product is associated with a product price, the historical user action is also associated with that product price. In some embodiments, the historical user actions may be associated with one or more users (e.g., of an e-commerce website). In some embodiments, the historical user action data used to make the actual price interval determinations may be associated with a predetermined time interval. The frequency (a count of the number of historical user actions) is determined for each product price that is associated with a category.

The frequency of a user's historical user actions with respect to various product prices is assumed to represent user inclinations towards those product prices. For example, within one category, assume that the frequency of user A's historical user actions that are associated with products corresponding to product prices in a lower price interval is much higher than the frequency of user A's historical user actions that are associated with products corresponding to product prices in a higher price interval. In this example, it is easily determined that the user A's inclination is towards lower price intervals. However, in practice, when users select products, their user actions are generally directed at products corresponding to various price intervals associated with the same category. And in many cases, the differentiation between historical user action frequencies associated with products corresponding to these multiple price intervals is not significant. That is, in many situations, the price intervals that may be used to reasonably embody users' price inclinations are not easily ascertainable.

To address this issue, the product prices of a category are preliminarily divided into multiple training price intervals. The users associated with the historical user actions are determined to belong to one or more user clusters based on these training price intervals. Users that are included in a user cluster determined for a training price interval are determined to be more inclined towards products associated with prices in that training price interval. The determined user clusters are used to determine a product price within each training price interval at which historical user actions relating to products corresponding to that price are the most stable. This price associated with the most stable historical user actions in a training price interval is referred to as the “actual price interval boundary point.” Then, the actual price interval boundary points determined to correspond to training price intervals are used to determine the actual price intervals associated with the category.

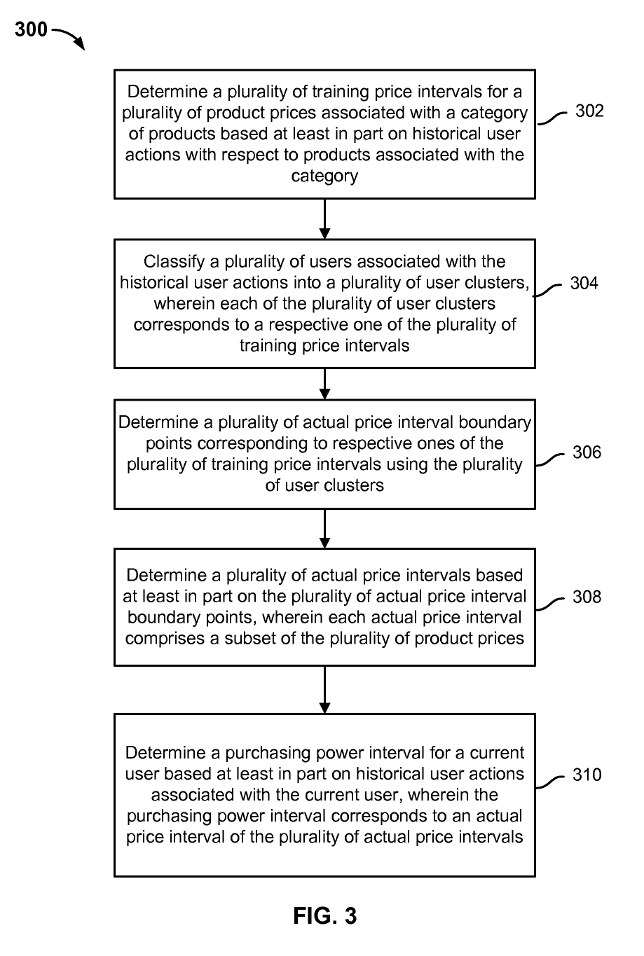

Examples of determining training price intervals, user clusters, and actual price intervals associated with a category are described below with FIGS. 3, 4, and 5.

In some embodiments, prior to executing 202 described above, product prices associated with the category can be discretized to reduce the dimensionality of product prices in the category. This way, the volume of computations can be simplified. For example, each product price may be divided by a predetermined discrete parameter (e.g., the predetermined discrete parameter is 10), rounded (up or down) to the closest one dollar, and this modified product price is used as the new price. Then, actual price intervals are determined based on the modified product prices.

At 204, a purchasing power interval is determined for a current user based at least in part on historical user actions associated with the current user with respect to the products associated with the category.

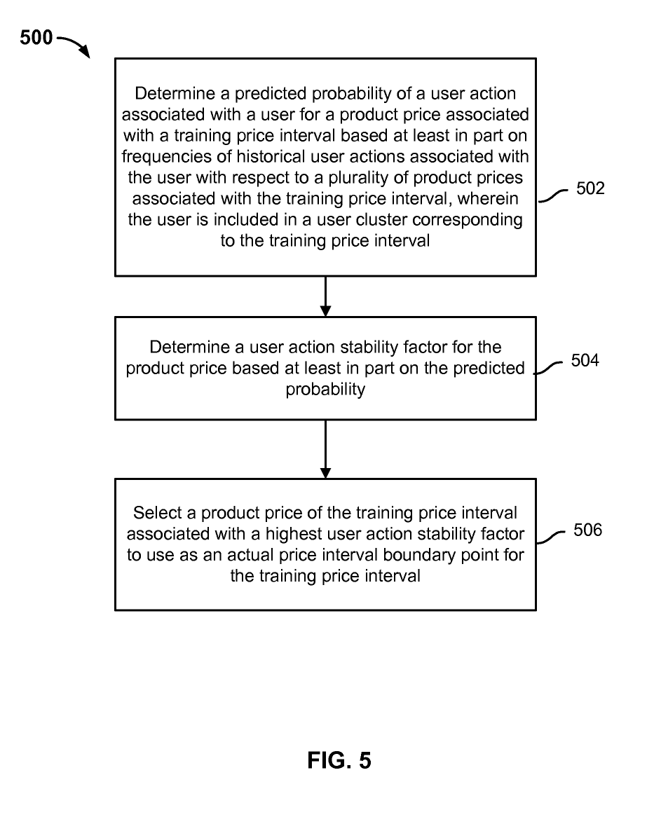

The purchasing power interval of a current user is determined based on the current user's historical user actions (e.g., user actions that were performed during a historical period) and is used to represent the price range of products from which the current user is predicted to most likely purchase. The purchasing power interval of the current user is determined to be an actual price interval from the plurality of actual price intervals determined for the category. An example of determining the purchasing power interval for a current user is described below with FIG. 5.

At 206, product information associated with one or more products of the products associated with the category is determined to be recommended to the current user based at least in part on an actual price interval of the plurality of actual price intervals that corresponds to the purchasing power interval. The actual price interval associated with the category that matches the purchasing power interval is determined as the matching actual price interval. Information associated with products of the category whose prices fall within the matching actual price interval is recommended to the current user. For example, such product information may be presented to the current user at the e-commerce website or may be sent to an email address associated with the current user. This way, the product information that is recommended to the current user is determined from an actual price interval from which the current user is predicted to more likely purchase from given the current user's historical user actions.

FIG. 3 is a flow diagram showing an embodiment of a process for determining a plurality of actual price intervals associated with a category and a purchasing power interval for the current user. In some embodiments, process 300 is implemented at system 100 of FIG. 1. In some embodiments, at least a portion of 202 and 204 of process 200 of FIG. 2 is implemented using process 300.

At 302, a plurality of training price intervals is determined for a plurality of product prices associated with a category based at least in part on historical user actions with respect to products associated with the category.

The product prices associated with products of a category are divided into at least two continuous training price intervals, where each training price interval comprises at least one product price of the products associated with the category. In some embodiments, the product prices associated with products of the category are divided into at least two training price intervals based on the frequencies of historical user actions associated with products corresponding to the product prices. The historical user actions are associated with one or more users and may be associated with a predetermined time interval. At least some of the users associated with this set of historical user action data may be referred as, in various embodiments, a “user sample.”

The following is a first example of dividing the product prices of the category into one or more training price intervals:

In the first example, the product prices of the category associated with the user sample are ranked from low to high in a list and the frequency of historical user actions that are associated with products for each product price is determined. In the ranked list, the product price that is lowest in value is ranked first (i.e., highest on the ranked list). The frequency of historical user actions that are associated with products for a particular product price comprises a count of the one or more types of historical user actions that were performed with respect to one or more products of the category that are associated with that product price. The total frequency of historical user actions with respect to all product prices associated with the category is also determined. The total frequency of historical user actions comprises the sum of all frequencies of historical user actions across all product prices associated with the category. The total frequency of historical user actions with respect to all product prices associated with the category is divided into equal parts based on a predetermined quantity. In various embodiments, the predetermined quantity is chosen (e.g., by a system administrator) to be equal or greater than two and represents the number of training price intervals to be determined for the category. For example, if the product prices in a single category are to be divided into two training price intervals (e.g., the predetermined quantity is two), then the total frequency of historical user actions performed with respect to products in the single category is divided into two equal parts. In the first example, the equal division point refers to a quotient of the value of the total frequency divided by the predetermined quantity. For example, if the total frequency of historical user actions associated with a category is eight and if the predetermined quantity is two, then the (total frequency)/(predetermined quantity)=8/2=4 historical user actions. So in this first example, the total frequency is divided into two equal portions of equal size, where each part comprises four historical user actions. Therefore, the two portions of the total frequency of eight may be associated with an equal division point of four. In various embodiments, a “training price interval boundary point” refers to point (a product price) on which the training price intervals are to be based. For example, if one training price interval boundary point was found, then a first training price interval comprises the product price associated with the training price interval boundary point and all higher ranked product prices associated with the category and the second training price interval comprises the training price interval boundary point and all lower ranked product prices associated with the category. In the first example, the training price interval boundary point is determined based on the equal division point, as will be described in the examples below. Therefore, returning to the previous example, the first training price interval comprises prices (equal to and) less than (e.g., and inclusive of) the training price interval boundary point of four and the second training price interval comprises prices (equal to and) greater than the training price interval boundary point of four. In some embodiment, the training price interval boundary point is alternatively included in one of two neighboring training price intervals.

The following is a second example of dividing the product prices of the category into one or more training price intervals:

In the second example, the product prices of the category associated with the user sample are ranked from low to high in a list and a cumulative value of the frequencies of historical user actions is determined for each product price in the ranked list of product prices for a category. In the ranked list, the product price that is lowest in value is ranked first (i.e., highest on the ranked list). The cumulative value for a product price comprises the sum of its corresponding frequency of historical user actions with the frequencies of historical user actions corresponding to all, if any, product prices ranked higher (product prices that are lower in value than the product price under consideration) than that product price in the ranked list. The cumulative value of the lowest ranked product price (the product price with the highest value), which comprises the sum of the frequencies of historical user actions corresponding to all product prices, is determined as a cumulative total for the product prices of the category. The cumulative total is divided into equal parts based on a predetermined quantity. In various embodiments, the predetermined quantity is chosen (e.g., by a system administrator) to be equal or greater than 2 and represents the number of training price intervals to be determined for the category. In the second example, the equal division point refers to a quotient of the value of the cumulative total divided by the predetermined quantity. In the second example, a product price whose cumulative value is closest in value to the equal division point is selected as a training price interval boundary point. In some embodiments, the training price interval boundary point is determined as the product price whose cumulative value is closest in value to the equal division point and is also greater than or equal to the equal division point. For example, in the event that the predetermined quantity is two, the first training price interval comprises prices (equal to and) less than the training price interval boundary point and the second training price interval comprises prices (equal to and) greater than the training price interval boundary point.

The following is an example of applying the second example of dividing the product prices of the category into one or more training price intervals: The product prices associated with a category of products are “$20,” “$30,” “$40,” and “$50.” The four product prices are ranked from low to high: “$20,” “$30,” “$40,” and “$50.” A frequency of historical user actions with respect to each product price is determined. The frequency of historical user actions with respect to products corresponding to the product price of “$20” is 50. The frequency of historical user actions with respect to products corresponding to the product price of “$30” is 80. The frequency of historical user actions with respect to products corresponding to the product price of “$40” is 60. The frequency of historical user actions with respect to products corresponding to the product price of “$50” is 110. Then, successive calculations are performed to obtain the cumulative value of the frequencies of historical user actions for each product price associated with the category. As described above, the cumulative value for a product price is the sum of its corresponding frequency of historical user actions and the frequencies of historical user actions corresponding to higher ranked product prices. Therefore, the cumulative values corresponding to the first price of $20, the second ranked product price of $30, the third ranked product price of $40, and the fourth ranked product price of $50 are, respectively, 50, 130 (=50+80), 190 (=50+80+60), and 300 (=50+80+60+110). 300 represents the cumulative total associated with the category. In this example, the predetermined quantity is two so two training price intervals are to be determined. The cumulative total of 300 is divided by two to arrive at the equal division point of 150. Given that the equal division point is 150, the cumulative value that is greater than or equal to the equal division point and is the closest in value from the equal division point is 190, which corresponds to the third ranked product price of “$40.” As such, the product price of “$40” is determined as the training price interval boundary point to be used to determine the training price intervals. In this example, the price interval from “$20” to “$40,” which includes the product price of “$30,” is configured to comprise the first training price interval, and the price interval from “$40” to “$50” is configured to comprise the second training price interval. In some embodiments, the training price interval boundary point may be included in either one or both of the immediate training price intervals that it is used to create. In some embodiments, the training price interval boundary point is determined as the product price that corresponds to the cumulative value that is the closest to, but not necessarily greater than, the equal division point. In the example described above, the cumulative value that is the closest to, but is not necessarily greater than, the equal division point is 130, which corresponds to the product price of “$30.” Therefore, in some embodiments, “$30” may be determined as the training price interval boundary point to be used to determine the training price intervals.

The following is a third example of dividing the product prices of the category into one or more training price intervals:

In this third example, the training price intervals may be determined on the basis of the multiplication product of the numerical value of each product price and the frequency of historical user actions with respect to products corresponding to that product price. First, the product prices of the category associated with the user sample are ranked from low to high in a list. The multiplication product of each product price and the frequency of historical user actions with respect to products corresponding to that product price is calculated.

A cumulative multiplication value of multiplication products is determined for each product price in the ranked list of product prices for a category. In the ranked list, the product price that is lowest in value is ranked first (i.e., highest on the ranked list). The cumulative multiplication value for a product price comprises the sum of its corresponding multiplication product and multiplication products corresponding to all, if any, product prices ranked higher (product prices that are lower in value than the product price under consideration) in the ranked list. The cumulative multiplication value of the lowest ranked product price (the product price with the highest value), which comprises the sum of multiplication products corresponding to all product prices, is determined as a cumulative multiplication product total for the product prices of the category. The cumulative multiplication product total is divided into equal parts based on a predetermined quantity. In various embodiments, the predetermined quantity is chosen (e.g., by a system administrator) to be equal or greater than two and represents the number of training price intervals to be determined for the category. In the third example, the equal division point refers to a quotient of the value of the cumulative multiplication product total divided by the predetermined quantity. In the third example, a product price whose cumulative multiplication value is closest in value to, but is not necessarily greater than, the equal division point is selected as a training price interval boundary point. In some embodiments, the training price interval boundary point is determined as the product price whose cumulative multiplication value is closest in value to the equal division point and is also greater than or equal to the equal division point.

At 304, a plurality of users associated with the historical user actions is classified into a plurality of user clusters, wherein each of the plurality of user clusters corresponds to a respective one of the plurality of training price intervals.

Users' inclinations may be determined from their historical user actions with respect to products associated with different training price intervals. Therefore, the user action inclination for each training price interval may be used as a basis for dividing users into sets corresponding to each training price interval. For example, two training price intervals have been determined for a category of products. The training price interval associated with the lower range of prices is referred to as the low price training price interval and the training price interval associated with the higher range of prices is referred to as the high price training price interval. In the example, it is determined that user A has a greater inclination towards user actions in the high price training price interval than in the low price training price interval because more of user A's historical user actions correspond to products associated with the high price training price interval. Thus, the user can be assigned to a preset high price inclination user cluster corresponding to the high price training price interval. In the opposite situation, user B can be assigned to the preset low price inclination user cluster corresponding to the low-price training price interval if it is determined that more of user B's historical user actions correspond to products associated with the low price training price interval than in the high price training price interval.

In some embodiments, one or more user clusters corresponding to each training price interval are determined based at least in part on the frequencies of historical user actions by users included in the user sample with respect to products corresponding to the different product prices associated with the category. The training price intervals corresponding to the user clusters are the training price intervals towards which the users in the user clusters incline.

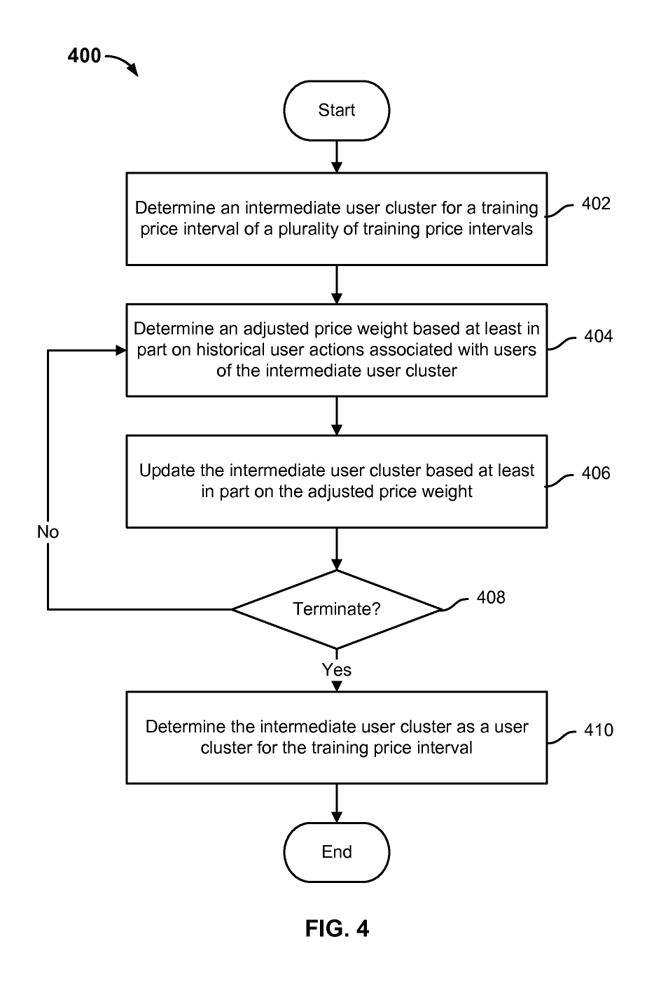

As described above, the price inclinations of users are generally not obvious because users may perform user actions with respect to products of a wide range of prices. However, distinct user inclinations are better distinguished when users are classified into various user clusters. FIG. 4 below illustrates an example of classifying users into different user clusters and determining a correspondence between a user cluster and a training price interval.

At 306, a plurality of actual price interval boundary points corresponding to respective ones of the plurality of training price intervals is determined using the plurality of user clusters.

In various embodiments, an actual price interval boundary point comprises a product price within a corresponding training price interval. In some embodiments, a predicted probability of user actions corresponding to each product price within a training price interval is determined using the user cluster determined for that training price interval. In some embodiments, the actual price interval boundary point determined for a training price interval comprises a product price that is associated with the greatest user action stability factor. An example of determining an actual price interval boundary point for a training price interval is described in further detail with FIG. 5 below.

At 308, a plurality of actual price intervals is determined based at least in part on the plurality of actual price interval boundary points, wherein each actual price interval comprises a subset of the plurality of product prices.

An actual price interval boundary point is determined for each corresponding training price interval. In various embodiments, the actual price interval boundary points determined for the training price intervals are used to determine a corresponding number of actual price intervals. For example, the actual price interval boundary points corresponding to two adjacent training price intervals form an actual price interval. Also, for example, the product prices through the minimum product price and the closest actual price interval boundary point forms an actual price interval. Furthermore, for example, the product prices through the maximum product price and the closest actual price interval boundary point forms an actual price interval.

At 310, a purchasing power interval is determined for a current user based at least in part on historical user actions associated with the current user, wherein the purchasing power interval corresponds to an actual price interval of the plurality of actual price intervals.

Each purchasing power interval corresponds to a determined actual price interval. A purchasing power interval is selected for each user based on the historical user action probability statistics determined for the user in various actual price intervals, as will be described below.

A current user's frequency of historical user actions with respect to products corresponding to each product price in the category is used to determine a predicted probability of user action by the current user with respect to products associated with each product price in each actual price interval in the category. The combination of predicted probabilities of user actions by the user with respect to the product prices in an actual price interval is used to obtain the user action probability for that actual price interval. The actual price interval associated with the highest user action probability is determined as the purchasing power interval of the user.

For example, the probability of user action by a current user with respect to products associated with one product price in an actual price interval may be expressed using the following formula:

$${P}_{t} ( s ) = \frac{{N}_{t} ( s )}{{\sum }_{j = 1}^{h} {N}_{j} ( s )} , \qquad formula ( 1 )$$

where Pₜ (s) is the predicted probability of a user action by user s with regard to price t in the actual price interval; Nₜ(s) is the frequency of historical user actions committed by user s with respect to products corresponding to price t in the actual price interval; Nⱼ(s) is the frequency of historical user actions committed by user s with respect to products corresponding to price j in the actual price interval; and h is the number of all product prices within the category. In formula (1), s, t, j and h are natural numbers. Examples of the user actions include purchasing, browsing, bookmarking, listing, and searching actions associated with products.

The predicted probability of user action by the current user in an actual price interval can be expressed using the following formula:

Uₗ(s)=Σₜ₌₁^{f}Pₜ(s), formula (2)

where Uₗ(s) is the predicted probability of user action by user s in actual price interval l; Pₜ(s) is the predicted probability of user action by user s with regard to price t in actual price interval l; and f is the number of product prices in actual price interval l, where s, l, t, and f are natural numbers.

Thus, the purchasing power interval corresponding to the current user is determined as the actual price interval, l, that is associated with the greatest predicted probability of user action, Uₗ(s). As described above for process 200 of FIG. 2, the determined purchasing power interval of a current user is used to determine product information to recommend to the current user. For example, product information associated with products whose prices are associated with the current user's purchasing power interval (which is the actual price interval corresponding to the highest predicted probability of user action by the current user) is recommended to the current user.

FIG. 4 is a flow diagram showing an embodiment of a process for determining user clusters that correspond to training price intervals. In some embodiments, process 400 is implemented at system 100 of FIG. 1. In some embodiments, 304 of process 300 is implemented at least in part using process 400.

Process 400 describes an example technique of sorting (at least some) users of a user sample into user clusters, where each user cluster corresponds to a training price interval.

At 402, an intermediate user cluster is determined for a training price interval of a plurality of training price intervals.

For one user in the user sample, the multiplication product of the frequency of user actions by that user with respect to products for one product price in one training price interval and the price weight for that price is used as the price inclination factor of the user for that product price. The price weight can be a predetermined parameter (e.g., the predetermined parameter is one) during the first intermediate user cluster determination. When the user cluster classifications are updated in subsequent iterations, the price weight may be adjusted in subsequent iterations.

The sum of the user's price inclination factors corresponding to all product prices corresponding to one training price interval comprises the user action inclination factor of that user for that training price interval. The following formula is an example formula that may be used to calculate user action inclination factors:

Qᵣ(s)=Σᵢ₌₁^{k}qᵢ*Nᵢ(s), formula (3)

where Qᵣ (s) is the user action inclination factor for user s in training price interval r; qᵢ is the price weight of price i; Nᵢ(s) is the frequency of user actions by user s with respect to products corresponding to price i; and k is the total number of prices in training price interval r, where s, i, r, and k are natural numbers.

For each user, the user action inclination factor of the user with regard to each training price interval associated with the category is determined. Then the training price interval that is associated with the highest user action inclination factor is determined as the training price interval to which the user inclines. Users that incline towards the same training price interval are classified into the same intermediate user cluster corresponding to the training price interval. That a user belongs to a user cluster that corresponds to a particular training price interval indicates that the user's user actions are more inclined (e.g., likely to be performed with respect) to product prices in that training price interval.

At 404, an adjusted price weight is determined based at least in part on historical user actions associated with users of the intermediate user cluster. In some embodiments, the price weight is referred to as the “iteration variable.”

The frequency of historical user actions with respect to products corresponding to each product price in the determined intermediate user cluster is used as a basis for calculating an adjusted price weight for that product price.

When performing iterative calculations, the mean frequency of user actions with respect to products corresponding to a product price by the one or more users in the same intermediate user cluster corresponding to a training price interval with which the price is associated is determined. This mean frequency is used as the adjusted price weight for that price for all users.

At 406, the intermediate user cluster is updated based at least in part on the adjusted price weight.

For example, the adjusted price weight, qᵢ, is input again into formula (3), Qᵣ(s)=Σᵢ₌₁^{k}qᵢ*Nᵢ(s), that was described above to determine an updated user action inclination factor for user s in training price interval r. The users are then reclassified into user clusters corresponding to respective training price intervals based on their corresponding updated user action inclination factors corresponding to the training price intervals. Thus, the intermediate user cluster is updated for each training price interval.

At 408, it is determined whether an iterative computation termination condition has been met. In the event that the condition has been met, control is transferred to 410. Otherwise, control is transferred to 404. Because process 400 comprises an iterative computation, 404 and 406 may be performed one or more times until an iterative computation termination condition is met.

An iterative computation termination condition may be set to prevent the iterations from proceeding endlessly. One example of an iterative computation termination condition may be the number of times of computing the adjusted price weight meeting a preset iteration count threshold value. When the number of the iterative computations reaches this threshold value, then the iterative computations end.

Another example of an iterative computation termination condition comprises the following: for one price in one training price interval, the square of the difference between price weights that are determined on two adjacent occasions for that price is used as the iteration component, the sum of all iteration components in the category is used as the iteration vector, whether the difference between the adjacent iteration vectors determined on two occasions lies within a predetermined threshold value range is determined; if the difference lies within the predetermined threshold value range, then the iterative computation termination condition is met and the process stops; otherwise, iterative computations continue.

At 410, the intermediate user cluster is determined as a user cluster for the training price interval. The updated intermediate user cluster determined for each training price interval prior to the iterative computation termination condition being met is determined as the user cluster corresponding to that training price interval to be used for further processing.

In some embodiments, a subset of all users associated with the user sample may be used to determine one or more iterative price weights. Then the iterative price weights may be used to determine the user clusters associated with all of the users of the user sample. Using only a subset of the users of the user sample to determine price weights may speed up the performance of process 400 in determining user clusters.

FIG. 5 is a flow diagram showing an embodiment of a process of determining an actual price interval boundary point corresponding to a training price interval. In some embodiments, process 500 is implemented at system 100. In some embodiments, 306 of process 300 of FIG. 3 is at least partially implemented using process 500.

Process 500 is an example process that is used to determine an actual price interval boundary point for a training price interval.

At 502, a predicted probability of a user action associated with a user for a product price associated with a training price interval is determined based at least in part on frequencies of historical user actions associated with the user with respect to a plurality of product prices associated with the training price interval, wherein the user is included in a user cluster corresponding to the training price interval.

The predicted probability of user action by a user with respect to a certain price in a training price interval is the predicted probability that the user will perform a user action relating to one or more products corresponding to that price. The user for which the predicted probability is determined is included in a user cluster determined for that training price interval (e.g., using a process such as process 400 of FIG. 4). The predicted probability of user action by a user with respect to a certain price in a training price interval is determined for each user in the user cluster associated with the training price interval and for users in user clusters corresponding to each training price interval.

The predicted probability of user actions of a user with respect to a product price can be determined, for example, as the quotient of the frequency of historical user actions by that user with respect to products corresponding to that product price divided by the total frequency of user actions by that user with respect to products across all product prices in the training price interval. That is, the predicted probability of user action for a user for a product price may be determined, for example, using the following formula:

$${P}_{t} ( s ) = \frac{{N}_{i} ( s )}{{\sum }_{j = 1}^{k} {N}_{j} ( s )} , \qquad formula ( 4 )$$

where Pᵢ(s) is the predicted probability of a user action by user s for product associated with price i of a training price interval; Nᵢ(s) is the frequency of historical user actions by user s with respect to products associated with price i of the training price interval; Nⱼ(s) is the frequency of historical user actions by user s with respect to products associated with price j of the training price interval; and k is the total number of prices in the training price interval.

At 504, a user action stability factor for the product price is determined based at least in part on the predicted probability.

The user action stability factor for a product price may be determined based on the predicted probabilities of user action for the price corresponding to all users in the user cluster corresponding to the training price interval that includes the price. For example, the user action stability factor for the price is determined as the inverse of the entropy value of the user action probability for that price with regard to all users in the user cluster corresponding to the training price interval in which that price is located. That is, the stability factor for a product price may be determined, for example, by the following formula:

$$H ( {P}_{i} ) = - \frac{1}{{\sum }_{s = 1}^{M} {P}_{i} ( s ) * log ( {P}_{i} ( s ) )} , \qquad formula ( 5 )$$

where H (Pᵢ) is the user action stability factor for price i; −Σ_{S=1}^{M}Pᵢ(s)*log(Pᵢ(s)) is the entropy value of the user action probability for price i with regard to all users in the user cluster corresponding to the training price interval with which price i is associated; Pᵢ(s) is the predicted probability of user action by user s for price i; and M is the number of all users in the user cluster corresponding to the training price interval with which price i is associated.

At 506, a product price of the training price interval associated with a highest user action stability factor is selected to use as an actual price interval boundary point for the training price interval. Once the user action stability factor has been determined for each product price of each training price interval, the product price of each training price interval that is associated with the highest user action stability factor is selected as the actual price interval boundary point corresponding to that training price interval.

As described above, the frequencies of historical user actions with respect to products corresponding to various product prices are used as a basis to determine actual price intervals, which are determined based on several factors versus one or few used in the conventional determination of price intervals. The determination of actual price intervals on the basis of historical user action frequencies does not require manual filtering of prices. Therefore, all prices can be retained, which avoids the problem of filtering out potentially authentic prices. By determining actual price intervals on the basis of frequencies of historical user actions, it is possible to avoid the problem of creating price intervals from even narrow price ranges associated with a category of products. Furthermore, a purchasing power interval for a user may be determined as an actual price interval and thus, products associated with that actual price interval that serves as the purchasing price interval may be recommended to the user.

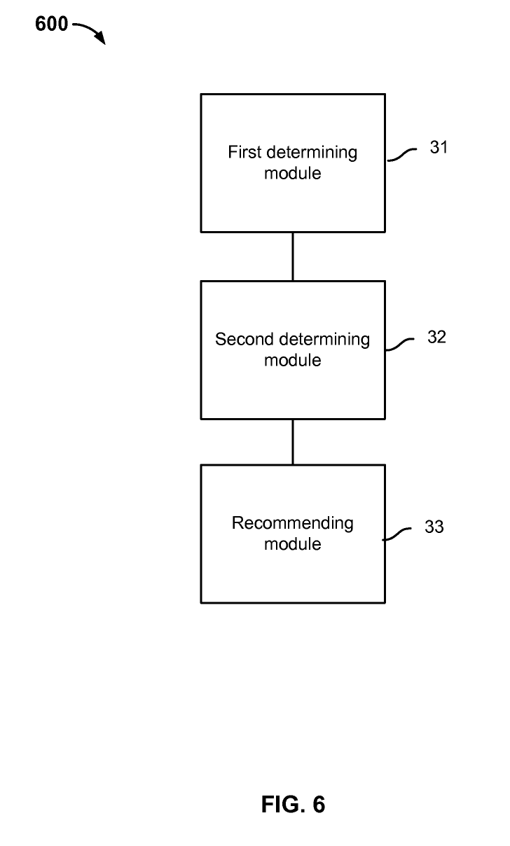

FIG. 6 is a diagram showing an embodiment of a system for recommending product information. In the example, system 600 includes first determining module 31, second determining module 32, and recommending module 33.

The modules can be implemented as software components executing on one or more processors, as hardware such as programmable logic devices and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

First determining module 31 is configured to classify a plurality of product prices associated with a category of products into a plurality of actual price intervals based at least in part on historical user actions associated with a plurality of users with respect to products associated with the category, where each actual price interval comprises a subset of the plurality of product prices.

In some embodiments, in determining the plurality of actual price intervals, first determining module 31 is also configured to determine a plurality of training price intervals for the plurality of product prices. Then, first determining module 31 is configured to classify the plurality of users associated with the historical user actions into a plurality of user clusters, wherein each of the plurality of user clusters corresponds to a respective one of the plurality of training price intervals. For example, user clusters corresponding to respective ones of the training price intervals are determined over iterative computations. First determining module 31 is configured to determine a plurality of actual price interval boundary points corresponding to respective ones of the plurality of training price intervals using the plurality of user clusters.

In some embodiments, first determining module 31 is configured to determine an actual price interval boundary point for a training price interval by determining a predicted probability of a user action associated with a user for a product price associated with the training price interval based at least in part on historical frequencies of user actions associated with the user with respect to a plurality of product prices associated with the training price interval, wherein the user is included in a user cluster corresponding to the training price interval. Then, first determining module 31 is configured to determine a user action stability factor for the product price based at least in part on the predicted probability and to select a product price of the training price interval associated with a highest user action stability factor to use as an actual price interval boundary point for the training price interval.

First determining module 31 is configured to determine a plurality of actual price intervals based at least in part on the plurality of actual price interval boundary points.

Second determining module 32, which is connected to first determining module 31, is configured to determine a purchasing power interval for a current user. In some embodiments, second determining module 32 is configured to determine the current user's purchasing power interval based at least in part on historical user actions associated with the current user, wherein the purchasing power interval corresponds to an actual price interval of the plurality of actual price intervals.

Recommending module 33, which is connected to a second determining module 32, is configured to recommend product information to the user based on the purchasing power interval of the current user. In some embodiments, recommending module 33 is configured to determine an actual price interval that matches the current user's purchasing power interval and then product information associated with products that correspond to the matching actual price interval are recommended to the current user.

Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
classify a plurality of product prices associated with a category of products into a plurality of actual price intervals based at least in part on historical user actions associated with a plurality of users with respect to products associated with the category, wherein each actual price interval comprises a subset of the plurality of product prices;
determine a purchasing power interval for a current user based at least in part on historical user actions associated with the current user with respect to the products associated with the category; and
determine product information associated with one or more products of the products associated with the category to be recommended to the current user based at least in part on an actual price interval of the plurality of actual price intervals that corresponds to the purchasing power interval; and
one or more memories coupled to the one or more processors and configured to provide the one or more processors with instructions.

2. The system of claim 1, wherein to classify the plurality of product prices associated with the category of products into the plurality of actual price intervals includes to:
determine a plurality of training price intervals for the plurality of product prices based on the historical user actions;
classify the plurality of users associated with the historical user actions into a plurality of user clusters, wherein each of the plurality of user clusters corresponds to a respective one of the plurality of training price intervals;
determine a plurality of actual price interval boundary points corresponding to respective ones of the plurality of training price intervals using the plurality of user clusters; and
determine the plurality of actual price intervals based at least in part on the plurality of actual price interval boundary points.

3. The system of claim 2, wherein to classify the plurality of users associated with the historical user actions into the plurality of user clusters includes to:
determine an intermediate user cluster for a training price interval of the plurality of training price intervals;
determine an adjusted price weight based at least in part on historical user actions associated with users of the intermediate user cluster;
update the intermediate user cluster based at least in part on the adjusted price weight; and
determine whether an iterative computation termination condition has been met, in the event that the iterative computation termination condition has been met, determine the adjusted price weight based at least in part on historical user actions associated with users of the intermediate user cluster and in the event that the iterative computation termination condition has not been met, use the intermediate user cluster as a user cluster for the training price interval.

4. The system of claim 3, wherein the iterative computation termination condition comprises a number of times the adjusted price weight has been determined.

5. The system of claim 2, wherein to determine the plurality of actual price interval boundary points includes to:
determine a predicted probability of user action associated with a user for a product price associated with a training price interval of the plurality of training price intervals based at least in part on frequencies of historical user actions associated with the user with respect to product prices associated with the training price interval, wherein the user is included in a user cluster of the plurality of user clusters corresponding to the training price interval;
determine a user action stability factor for the product price based at least in part on the predicted probability; and
select a selected product price of the training price interval associated with a highest user action stability factor to use as an actual price interval boundary point for the training price interval.

6. The system of claim 1, wherein to determine the purchasing power interval for the current user includes determining a user action probability for each actual price interval of the plurality of actual price intervals.

7. The system of claim 6, wherein the actual price interval of the plurality of actual price intervals associated with a highest user action probability is determined as the purchasing power interval of the current user.

8. A method, comprising:
classifying, using one or more processors, a plurality of product prices associated with a category of products into a plurality of actual price intervals based at least in part on historical user actions associated with a plurality of users with respect to products associated with the category, wherein each actual price interval comprises a subset of the plurality of product prices;
determining a purchasing power interval for a current user based at least in part on historical user actions associated with the current user with respect to the products associated with the category; and
determining product information associated with one or more products of the products associated with the category to be recommended to the current user based at least in part on an actual price interval of the plurality of actual price intervals that corresponds to the purchasing power interval.

9. The method of claim 8, wherein classifying the plurality of product prices associated with the category of products into the plurality of actual price intervals includes:
determining a plurality of training price intervals for the plurality of product prices based on the historical user actions;
classifying the plurality of users associated with the historical user actions into a plurality of user clusters, wherein each of the plurality of user clusters corresponds to a respective one of the plurality of training price intervals;
determining a plurality of actual price interval boundary points corresponding to respective ones of the plurality of training price intervals using the plurality of user clusters; and
determining the plurality of actual price intervals based at least in part on the plurality of actual price interval boundary points.

10. The method of claim 9, wherein classifying the plurality of users associated with the historical user actions into the plurality of user clusters includes:
determining an intermediate user cluster for a training price interval of the plurality of training price intervals;
determining an adjusted price weight based at least in part on historical user actions associated with users of the intermediate user cluster;
updating the intermediate user cluster based at least in part on the adjusted price weight; and
determining whether an iterative computation termination condition has been met, in the event that the iterative computation termination condition has been met, determining the adjusted price weight based at least in part on historical user actions associated with users of the intermediate user cluster and in the event that the iterative computation termination condition has not been met, using the intermediate user cluster as a user cluster for the training price interval.

11. The method of claim 10, wherein the iterative computation termination condition comprises a number of times the adjusted price weight has been determined.

12. The method of claim 9, wherein determining the plurality of actual price interval boundary points includes:
determining a predicted probability of user action associated with a user for a product price associated with a training price interval of the plurality of training price intervals based at least in part on frequencies of historical user actions associated with the user with respect to product prices associated with the training price interval, wherein the user is included in a user cluster of the plurality of user clusters corresponding to the training price interval;
determining a user action stability factor for the product price based at least in part on the predicted probability; and
selecting a selected product price of the training price interval associated with a highest user action stability factor to use as an actual price interval boundary point for the training price interval.

13. The method of claim 8, wherein determining the purchasing power interval for the current user includes determining a user action probability for each actual price interval of the plurality of actual price intervals.

14. The method of claim 13, wherein the actual price interval of the plurality of actual price intervals associated with a highest user action probability is determined as the purchasing power interval of the current user.

15. A computer program product, the computer program product being embodied in a non-transitory computer readable storage medium and comprising computer instructions for:
classifying a plurality of product prices associated with a category of products into a plurality of actual price intervals based at least in part on historical user actions associated with a plurality of users with respect to products associated with the category, wherein each actual price interval comprises a subset of the plurality of product prices;
determining a purchasing power interval for a current user based at least in part on historical user actions associated with the current user with respect to the products associated with the category; and
determining product information associated with one or more products of the products associated with the category to be recommended to the current user based at least in part on an actual price interval of the plurality of actual price intervals that corresponds to the purchasing power interval.
